(19) United States
(12) Patent Application Publication
(10) Pub. No.: US 2011/0291829 A1
(43) Pub. Date: Dec. 1, 2011

(54) ELECTRONIC DEVICE WITH AN ALARM FUNCTION

(75) Inventors: TING-KAI WANG, Tu-Cheng (TW); BIN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/820,160

(22) Filed: Jun. 22, 2010

(30) Foreign Application Priority Data
May 31, 2010 (CN) 201010186815.5

(51) Int. Cl. G08B 21/00

(52) U.S. Cl. 340/540

(57) ABSTRACT

An electronic device includes a main body. The main body includes a hook and a sliding button. The hook is connected to the sliding button. A first groove and a second groove are defined in the main body and communicate with each other to form a slot. The hook protrudes from the first groove and the sliding button protrudes from the second groove. The main body further includes a sensor, a processing unit and an alarm unit. The sensor is located on an inner wall of the slot. When the sliding button is slid, the hook moves along with the sliding button and comes in contact with the sensor. The sensor generates a sensing signal due to the contact with the hook. When the processing unit receives the sensing signal from the sensor, the processing unit controls the alarm unit to sound an alarm.

### BACKGROUND

1. Technical Field

The present disclosure relates to an alarm function on an electronic device.

2. Description of Related Art

Due to portability, convenience, and easy operation of the electronic device, users often store their important or private data on electronic devices. However, other people can easily open the electronic device and access the important or private data when the owner of the device is unaware or not present. For the electronic apparatus with a cover, such as a notebook, when not in use, the user can close the cover. But the cover is easily opened and the data stored on the electronic device can be accessed.

Therefore, a new electronic device is desired to overcome the above-described shortcoming.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric diagram of an electronic device in accordance with one embodiment.

FIG. 2 is a partially cutaway view of a main body of the electronic device of FIG. 1.

FIG. 3 is a circuit module diagram of the electronic device of FIG. 1.

FIG. 4 a circuit module diagram of an electronic device in accordance with another embodiment.

### DETAILED DESCRIPTION

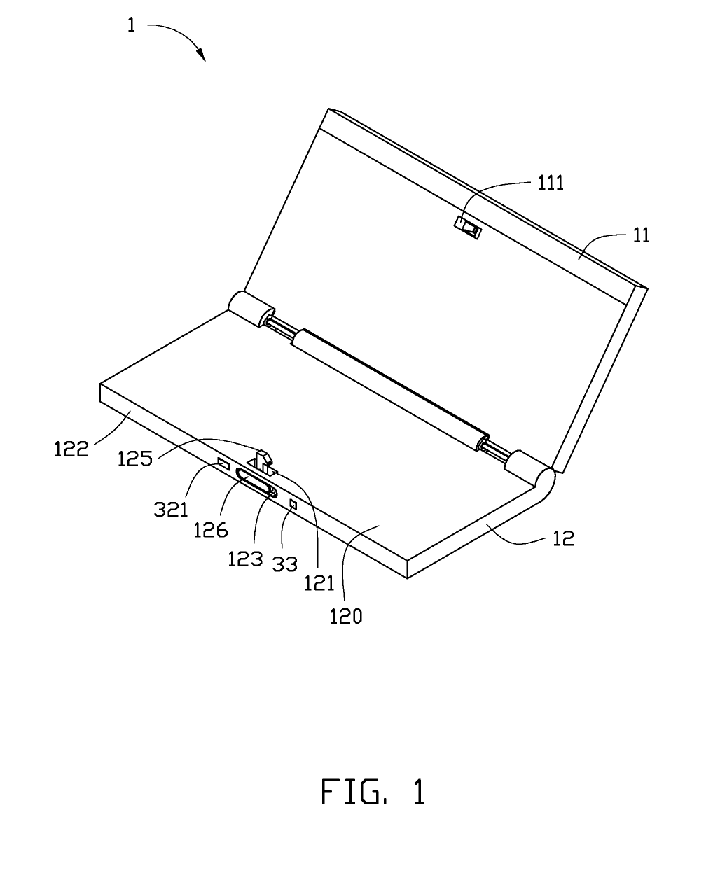

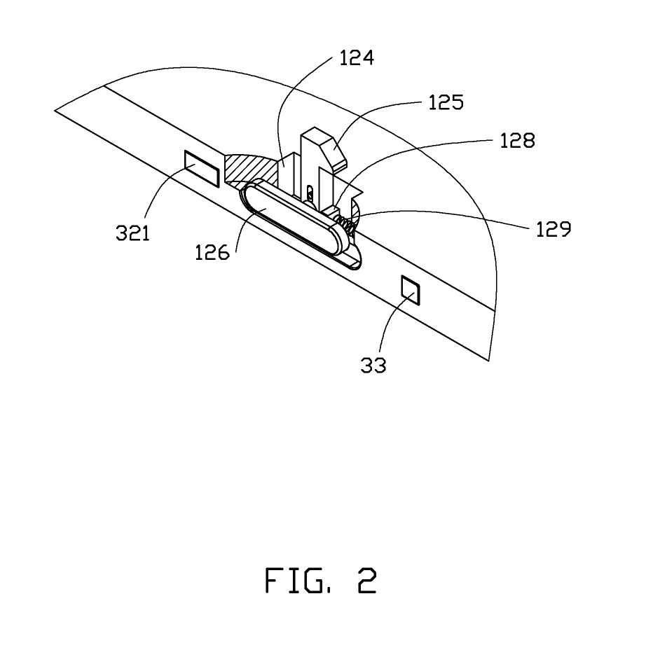

FIG. 1 is an isometric diagram of an electronic device 1 in accordance with one embodiment. The electronic device 1 includes a cover 11 and a main body 12. The main body 12 includes a top surface 120 and a side surface 122. A first groove 121 is defined in the top surface 120. A second groove 123 is defined in the side surface 122. The first groove 121 and the second groove 122 communicate with each other to form a slot 124, as shown in FIG. 2. The main body 12 further includes a hook 125 and a sliding button 126. The hook 125 protrudes from the first groove 121. The sliding button 126 protrudes from the second groove 123. A recess 111 that matches with the hook 125 is defined on a lower portion of the cover 11. The recess 111 matches with the hook 125 to lock the cover 11 to the main body 12. The sliding button 126 can lock the cover 11 when it is closed, and can be slid to make the hook 125 release from the recess 111 to unlock the cover 11 from the main body 12.

Referring to FIG. 2, the main body 12 further includes a sensor 128 and an elastic element 129. The sensor 128 is located on an inner wall of the slot 124 through the elastic element 129. In this illustrated embodiment, the elastic element 129 is a spring.

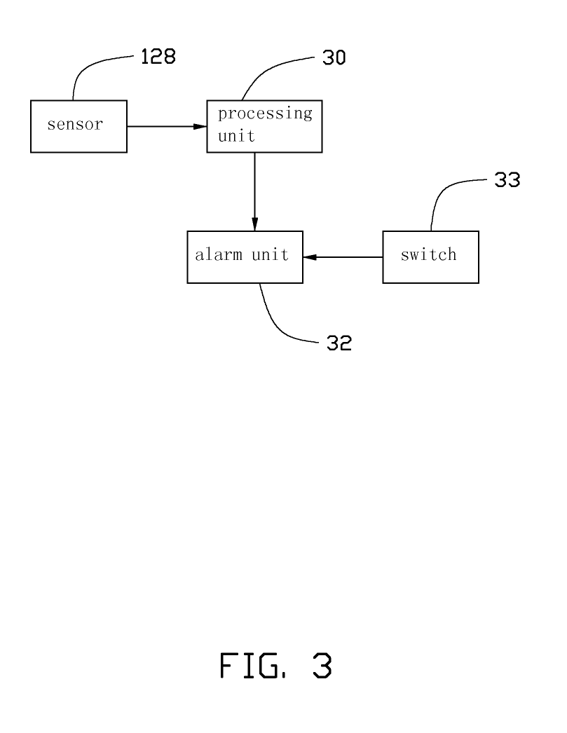

Referring to FIG. 3, the electronic device 1 further includes a processing unit 30, an alarm unit 32 and a switch 33. The sensor 128 is connected to the processing unit 30. When the sliding button 126 is slid, the hook 125 is moved by the sliding button 126 to contact the sensor 128. The sensor 128 generates a sensing signal due to the contact with the hook 125. When the sensing signal is generated by the sensor 128, the processing unit 30 receives the sensing signal from the sensor 128 and controls the alarm unit 32 to sound alarm. The switch 33 is for turning on/off the alarm unit 32. The alarm unit 32 can be turned on in an unsafe environment and can be turned off in a safe environment. In this illustrated embodiment, the sensor 128 is a pressure sensor.

In this embodiment, the alarm unit 32 includes a wireless signal sending device 321. When the processing unit 30 detects the sensing signal generated by the sensor 128, the processing unit 30 controls the wireless signal sending device 321 to send an alarm signal to a wireless signal receiving device (not shown). The wireless signal receiving device will sound an alarm. As the wireless signal receiving device sounds the alarm, the user can react to the alarm in time when the electronic device is opened. In this illustrated embodiment, the switch 33 is connected to the wireless signal sending device 321. The alarm unit 32 is turned on/off by turning on/off the wireless signal sending device 321.

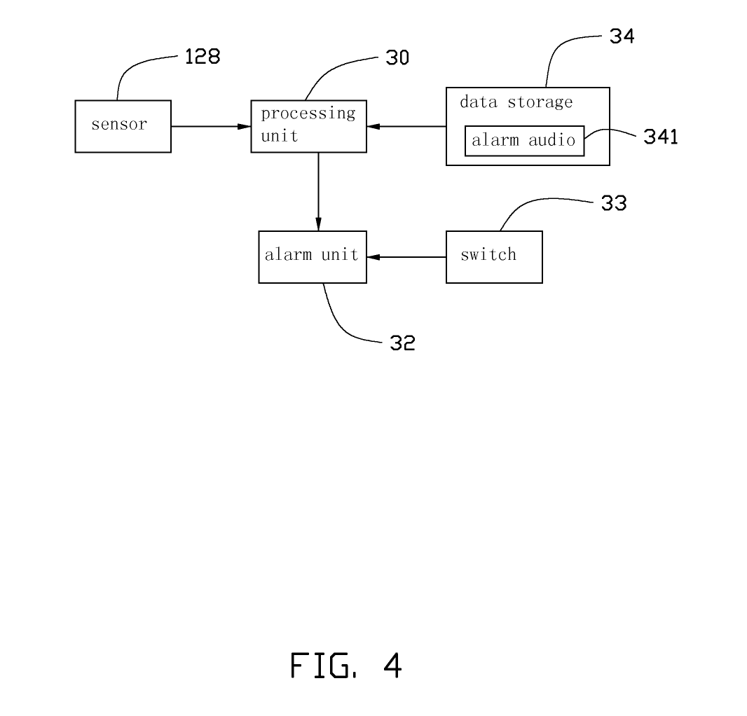

Referring to FIG. 4, an electronic device in accordance with another embodiment is similar to the electronic device 1 of FIGS. 1 through 3, except that the electronic device in accordance with the another embodiment further includes a data storage 34. A prerecorded audio alarm 341 is stored in the data storage 34. The alarm unit 32 includes an audio output unit (not shown) such as a speaker. When the sensing signal is generated by the sensor 128, the processing unit 30 obtains the prerecorded audio alarm 341 from the data storage 34 and sends the prerecorded audio alarm 341 through the audio output unit. In this illustrated embodiment, the switch 33 is connected to the audio output unit. The alarm unit 32 is turned on/off by turning on/off the audio output unit 321.

Although the present disclosure has been specifically described on the embodiments, the disclosure is not to be construed as being limited thereto. Various changes or modifications may be made to the embodiments without departing from the scope and spirit of the disclosure.

What is claimed is:

1. An electronic device comprising a main body, the main body comprising a hook and a sliding button, the hook being connected to the sliding button, a first groove and a second groove being defined in the main body and communicating with each other to form a slot, the hook protruding from the first groove, the sliding button protruding from the second groove, the main body further comprising a sensor, a processing unit and an alarm unit, the sensor being located on an inner wall of the slot, the processing unit being connected with the sensor and the alarm unit, when the sliding button is slid, the hook is moved by the sliding button and comes in contact with the sensor, the sensor generates a sensing signal due to the contact with the hook, the processing unit receives the sensing signal from the sensor and controls the alarm unit to sound an alarm.

2. The electronic device as described in claim 1, further comprising a switch, the switch being connected to the alarm unit and configured for turning on or off the alarm unit.

3. The electronic device as described in claim 1, wherein the sensor is located on the inner wall of the slot through an elastic element.

4. The electronic device as described in claim 3, wherein the elastic element is a spring.

5. The electronic device as described in claim 1, wherein the alarm unit comprises a wireless signal sending device, when receiving the sensing signal from the sensor, the processing unit controls the wireless signal sending device to send an alarm signal to a wireless signal receiving device, the wireless signal receiving device begins to alarm according to the alarm signal.

6. The electronic device as described in claim 1, further comprising a data storage, a prerecorded alarm audio being stored in the data storage, when receiving the sensing signal from the sensor, the processing unit obtains the prerecorded alarm audio from the data storage and outputs the prerecorded alarm audio through an audio output unit.

7. The electronic device as described in claim 1, wherein the sensor is a pressure sensor.

8. An electronic device, comprising:
a main body, the main body defining a first groove and a second groove, the first and second grooves being communicated with each other to form a slot, a hook protruding from the first groove, a sliding button protruding from the second groove and connecting to the hook, the siding button being configured to drive the hook to move in the first groove;
a sensor located on an inner wall of the slot, the sensor being configured to contact the hook to generate a sensing signal;
an alarm unit; and
a processing unit connected with the sensor and the alarm unit, the processing unit being configured to receive the sensing signal to control the alarm unit to sound an alarm.

9. The electronic device as described in claim 8, further comprising a switch, the switch being connected to the alarm unit and configured for turning on or off the alarm unit.

10. The electronic device as described in claim 8, wherein the sensor is located on the inner wall of the slot through an elastic element.

11. The electronic device as described in claim 10, wherein the elastic element is a spring.

12. The electronic device as described in claim 8, wherein the alarm unit comprises a wireless signal sending device, the processing unit is configured to control the wireless signal sending device to send an alarm signal if the processing unit receives the sensing signal from the sensor.

13. The electronic device as described in claim 8, further comprising a data storage connected to the processing unit, an alarm audio being pre-stored in the data storage, wherein the processing unit is configure to obtain the alarm audio from the data storage, and to output the alarm audio if the processing unit receives the sensing signal from the sensor.
